(19) United States
(12) Patent Application Publication
(10) Pub. No.: US 2015/0168885 A1
(43) Pub. Date: Jun. 18, 2015

(54) PRINTING DEVICE

(71) Applicant: Funai Electric Co., Ltd., Osaka (JP)

(72) Inventor: Katsuyuki Yoshida, Osaka (JP)

(21) Appl. No.: 14/546,122

(22) Filed: Nov. 18, 2014

(30) Foreign Application Priority Data
Dec. 16, 2013 (JP) 2013-258880

(51) Int. Cl. G03G 15/20

(52) U.S. Cl. CPC G03G 15/2039

(57) ABSTRACT

A printing device includes a heater that heats a fuser to fuse toner on a printing medium, a sense circuit that generates a temperature signal indicating a voltage value corresponding to a temperature of the fuser, a comparator that compares the voltage value indicated by the temperature signal with a threshold voltage value corresponding to a target temperature for the fuser and outputs a first signal that maintains the temperature of the fuser at the target temperature, a processor that executes a program after a power supply for the printing device is initiated and outputs a second signal that controls the temperature of the fuser, and an energization control circuit that, before the processor starts execution of the program, controls power distribution to the heater according to the first signal, and, after the processor has started the execution, controls the power distribution to the heater according to the second signal.

### TECHNICAL FIELD

The present invention relates generally to a printing device.

### BACKGROUND ART

Various techniques have been studied to reduce time required to begin printing immediately after power is turned on or for printing immediately after being restored from a deep sleep mode where supply of the main power is turned off. These printings are called a first print, and a majority of time required for the first print is occupied by a warm-up time to heat a fuser by a heater.

For example, Patent Document 1 discloses a technology with an image forming device comprising a main processor and a sub-processor where the sub-processor carries out a fusing temperature control program stored in a read only memory (ROM) when the power supply of the image forming device is turned on, and the main processor carries out a loader program. Further when a sub-program has been loaded into a random access memory (RAM), load end notification is conveyed to the sub-processor, and when the sub-processor receives the load end notification, the sub-program loaded into the RAM is executed instead of the fusing temperature control program.

According to Patent Document 1, the warming-up time can be reduced by starting up the fusing temperature control program when the power supply is turned on by the image forming device configured in this manner described above.

### RELATED ART DOCUMENTS

### Patent Documents

[Patent Documents] Japanese Unexamined Patent Application Publication No. 2011-227360

However, the conventional technique above cannot be applied to a printing device that comprises only one processor.

### SUMMARY OF THE INVENTION

In one aspect, embodiments of the invention provide a printing device having a configuration suitable to reduce the time required for first print.

A printing device according to one aspect of the present invention may include a heater that heats a fuser to fuse toner on a printing medium; a sense circuit that generates a temperature signal indicating a voltage value corresponding to a temperature of the fuser; a comparator that compares the voltage value indicated by the temperature signal with a threshold voltage value corresponding to a target temperature for the fuser and outputs a first energization control signal that maintains the temperature of the fuser at the target temperature; a processor that executes a program after a power supply for the printing device is initiated and outputs a second energization control signal that controls the temperature of the fuser; and an energization control circuit that, before the processor starts execution of the program, controls power distribution to the heater according to the first energization control signal, and, after the processor has started execution of the program, controls the power distribution to the heater according to the second energization control signal.

According to one or more embodiments of this configuration, the program may carry out temperature control according to a software function in the processor, and in parallel with all processing performed prior to starting the temperature control by the program, temperature control can be carried out by a hardware circuit. Accordingly, the heating of the fuser may be started at the same time when the power supply is turned on so that the time required for the first print can be reduced.

Further, for example, the processor may, by executing the program, further output a startup notification signal, and the energization control circuit comprises a disabling circuit that disables the first energization control signal according to the startup notification signal.

According to one or more embodiments of this configuration, more advanced temperature control may be performed using a software function because temperature control by a hardware circuit is disabled after temperature control using a software function is started.

Furthermore, for example, the printing device may further comprise a threshold voltage generating circuit that comprises a plurality of resistors connected in series and that outputs the threshold voltage value from a connection point of the resistors by applying a predetermined voltage to both ends of the resistors; and the disabling circuit comprises a transistor that connects the connection point and one of the end points of the threshold voltage generating circuit according to the startup notification signal.

According to one or more embodiments of this configuration, the first energization control signal can be disabled by shifting the threshold voltage.

According to another aspect of the present invention, a method for a printing device is provided, the method including: generating a temperature signal indicating a voltage value corresponding to a temperature of a fuser of toner; comparing the voltage value indicated by the temperature signal with a threshold voltage value corresponding to a target temperature for the fuser; outputting a first energization control signal that maintains the temperature of the fuser at the target temperature; controlling power distribution to a heater according to the first energization control signal; executing a program after a power supply for the printing device is initiated and outputting a second energization control signal that controls the temperature of the fuser; and controlling, before the processor starts execution of the program, power distribution to the heater according to the first energization control signal, and controlling, after the processor has started execution of the program, the power distribution to the heater according to the second energization control signal.

These overall or specific aspects may be realized by a system, a method, an integrated circuit, a computer program, or a recording medium such as a computer readable CD-ROM or the like, and may also be realized by various combinations of a system, method, integrated circuit, computer program or recording medium.

With the printing device according to one of the embodiments of the present invention, all processing performed prior to starting temperature control by the software function can be carried out in the processor in parallel to temperature control being carried out by the hardware circuit.

For example, with a conventional printing device comprising only a single processor, a process requiring considerable time, such as loading a program, must be carried out by the single processor when the power supply is initiated. In such cases, heating of the fuser begins at the same time as when the power supply is initiated by carrying out temperature control by the hardware function using the control circuit in parallel with processing so the time required for the first print can be reduced.

Furthermore, the configuration of one or more embodiments may be applied to, for example, the processor for carrying out temperature control in the fuser with a printing device comprising two or more processors. Accordingly, at the same time that the power supply is initiated, heating in the fuser is started by carrying out temperature control by the hardware function in the control circuit, and processes that require a considerable time, such as loading a program, are carried out in parallel and distributed in two or more processors so that the time required for fast printing can be reduced.

### BRIEF DESCRIPTION OF DRAWINGS

FIG. 1 is a perspective view illustrating one example of an external appearance of a printing device according to one or more embodiments of the present invention.

FIG. 2 is a block diagram illustrating one example of a functional configuration of the printing device according to one or more embodiments of the present invention.

FIG. 3 is a circuit diagram illustrating one example of a controller of the printing device according to one or more embodiments of the present invention.

FIG. 4 is a flowchart illustrating one example of an operation of the printing device according to one or more embodiments of the present invention.

### DETAILED DESCRIPTION OF EMBODIMENTS

Embodiments of the present invention are described in detail hereinafter with reference to drawings. Each embodiment described below illustrates one specific example of the present invention. Numerical values, shapes, materials, compositional elements, disposed positions and connection modes of the compositional elements, steps and order of steps are illustrated as an example and these are not intended to limit the present invention. Of the elements in the following embodiments, elements not described in the independent claims indicating the most significant concept are described as any given element.

A printing device according to one or more embodiments is a printing device having a configuration suitable for reducing the time required for a first print, and the device may be, for example, an electrophotographic printing device having a fuser that requires temperature control.

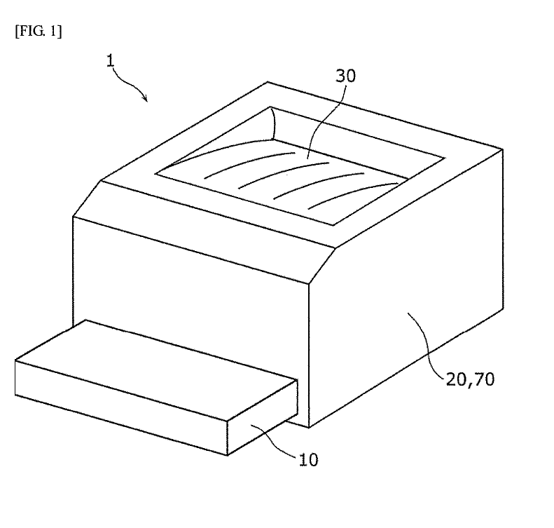

FIG. 1 is a perspective view illustrating one example of an external appearance of a printing device according to one or more embodiments. The printing device illustrated in FIG. 1 may comprise a paper feeding section 10, a printing unit 20, a paper discharging section 30, and power supply 70.

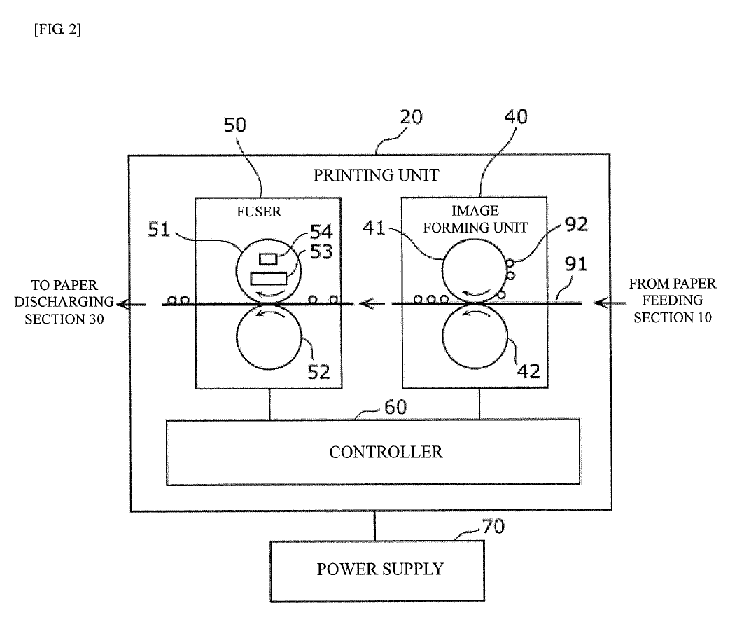

FIG. 2 is a block diagram illustrating one example of a functional configuration of the printing unit 20. FIG. 2 illustrates one example of a configuration of the printing unit 20 provided in an electrophotographic printing device.

The printing unit 20 may form any image using a toner 92 on a printing medium 91 such as a paper that is fed from the paper feeding section 10 and sent to the paper discharging section 30. The printing unit 20 may be configured with an image forming unit 40, a fuser 50, and a controller 60. The printing unit 20 may operate by electric power supplied from the power supply 70.

The power supply 70 may be, for example, a switching power supply device that converts alternating current voltage supplied from a commercial power supply to direct current voltage used in the operation of the printing unit 20.

The image forming unit 40 may comprise a photosensitive drum 41 and a transfer roller 42. The toner 92 may be adhered to a latent image formed on the photosensitive drum 41 using a light source (not illustrated) and then the adhered toner 92 may be transferred onto the printing medium 91 by the transfer roller 42.

The fuser 50 may comprise a heating roller 51 and a pressure roller 52. The toner 92 transferred onto the printing medium 91 may be fused to the printing medium 92 by applying heat and pressure. The heating roller 51 may comprise a heater 53 and a temperature sensor 54, and the temperature is controlled by the controller 60. For example, the heater 53 may be composed of a halogen heater, and the temperature sensor 54 may be composed of a thermistor.

The controller 60 may perform a complete set of processing in the printing device 1 including image processing and communication processing in addition to the control of the printing unit 20 including temperature control for the fuser 50 and is configured with a hardware circuit including a processor.

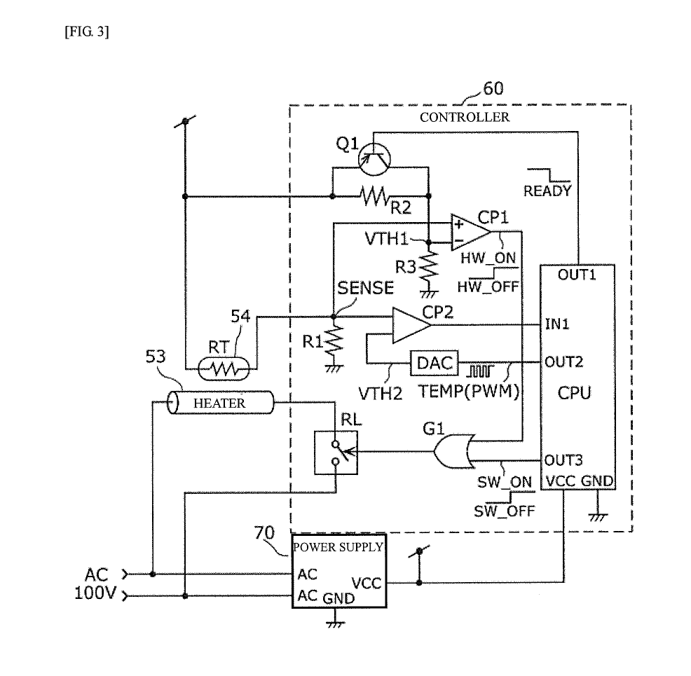

FIG. 3 is a circuit diagram illustrating one example of the controller 60. The power supply 70, heater 53, and temperature sensor 54 are illustrated with the controller 60 in FIG. 3.

As illustrated in FIG. 3, the controller 60 may comprise, for example, a processor (e.g., CPU), comparator CP1, CP2, digital to analog (DA) converters DAC, resistors R1, R2, and R3, transistor Q1, an OR gate G1, and a relay RL.

The temperature sensor 54 and the resistor R1 may be connected in series to configure a sense circuit. The sense circuit, with both ends connected to the power supply voltage and the ground voltage, may output, from the connection point between the temperature sensor 54 and the resistance R1, a temperature signal SENSE having a voltage value indicating the temperature (particularly the temperature of the heating roller 51) of the fuser 50.

The resistors R2 and R3 may be connected in series to configure a threshold voltage generating circuit. The threshold voltage generating circuit, with both ends connected to the power supply voltage and the ground voltage, may output, from the connection point of the resistors R2 and R3, a threshold voltage VTH1 that corresponds to a target temperature for the warm up of the fuser 50.

The comparator CP1 may compare the temperature signal SENSE and the threshold voltage VTH1 in an analog value and output a first energization control signal to maintain the temperature of the fuser 50 at the target temperature. The comparator CP1 is a circuit that can compare two input voltages without intervention by the processor, and it may be configured of, for example, an analog circuit such as an operational amplifier or the like. As an example, the first energization control signal may instruct power distribution (HW_ON) at an H level and instruct power disconnection (HW_OFF) at an L level.

The processor may output a startup notification signal READY and also output a reference signal TMEP and a second energization control signal to control a temperature of the fuser 50 by executing a predetermined program. As an example, the second energization control signal may instruct power distribution (SW_ON) at an H level and instruct power disconnection (SW_OFF) at an L level.

Here, a situation that requires considerable time to start the program in the processor is assumed. Such situation is not limited to any particular situation; however, the following situation is given as an assumed example. That is, the program may carry out a complete set of processing in the printing device 1 including the temperature control of the fuser 50, and as described in the background section, the processor launches the program in RAM (not illustrated) and then executes the program launched in RAM by executing a loader program stored in ROM (not illustrated).

The processor does not output the startup notification signal READY until the temperature control is started by the program, and outputs the second energization signal in the L level that instructs the power disconnection (SW_OFF).

After the temperature control is started by the program, the processor may output the startup notification signal READY in the L level that indicates the temperature control is started, and also output a reference temperature signal TEMP where a reference temperature is expressed with pulse width modulation (PWM). The DA converter DAC may convert the reference temperature signal TEMP to a threshold voltage VTH2 that corresponds to the reference temperature. The DA convertor DAC may be configured with, for example, a simple low-pass filter. The comparator CP2 may compare the temperature signal SENSE and the threshold voltage VTH2 in an analog value and then supply the comparison result signal indicating the result of the comparison to the processor.

The processor may read the temperature of the fuser 50 from the comparison result signal by sweeping the reference temperature expressed by the reference temperature signal TEMP within a predetermined range. Thereby, the processor may output the second energization control signal that instructs for power distribution (SW_ON) and power disconnection (SW_OFF) based on not only a simple temperature control logic by the threshold comparison, but also based on a more advanced temperature control logic such as hysteresis control or predictive control.

When the processor has a built-in analog to digital converter (ADC) that can convert a voltage acquired from the outside, the temperature signal SENSE may be converted to a digital value by the ADC. In this case, the DA converter DAC and the comparator CP2 may be omitted.

The OR gate G1, relay RL, and transistor Q1 may constitute the energization control circuit.

The OR gate G1 supplies to the relay RL an OR signal that indicates whether or not the power distribution (HW_{—} ON, SW_ON) is instructed by at least one of the first energization control signal and the second energization control signal.

The relay RL may carry out power distribution and power disconnection to the heater 53 according to the OR signal supplied from the OR gate G1. The relay RL may be, for example, an electronic relay configured with a triac, photo-coupler, or the like.

The transistor Q1 may conduct, or turn on, according to the startup notification signal READY, and connect an endpoint connected to the power supply voltage of the threshold voltage generating circuit that is configured with the resistors R2 and R3, and the connection points with the resistors R2 and R3. When the transistor Q1 is conducted, the first energization control signal becomes the L level to instruct the power disconnection (HW_OFF) at all times due to shifting of the threshold value voltage VTH1. The transistor Q1 is an example of a disabling circuit that disables the first energization control signal according to the start notification signal READY.

The energization control circuit with such configuration may carry out the power distribution and power disconnection to the heater 53 according to the first energization control signal until the temperature control is started by the program, and carry out the power distribution and power disconnection to the heater 53 according to the second energization control signal after the temperature control is started by the program.

An operation of the printing device 1 configured as described above will be described here below.

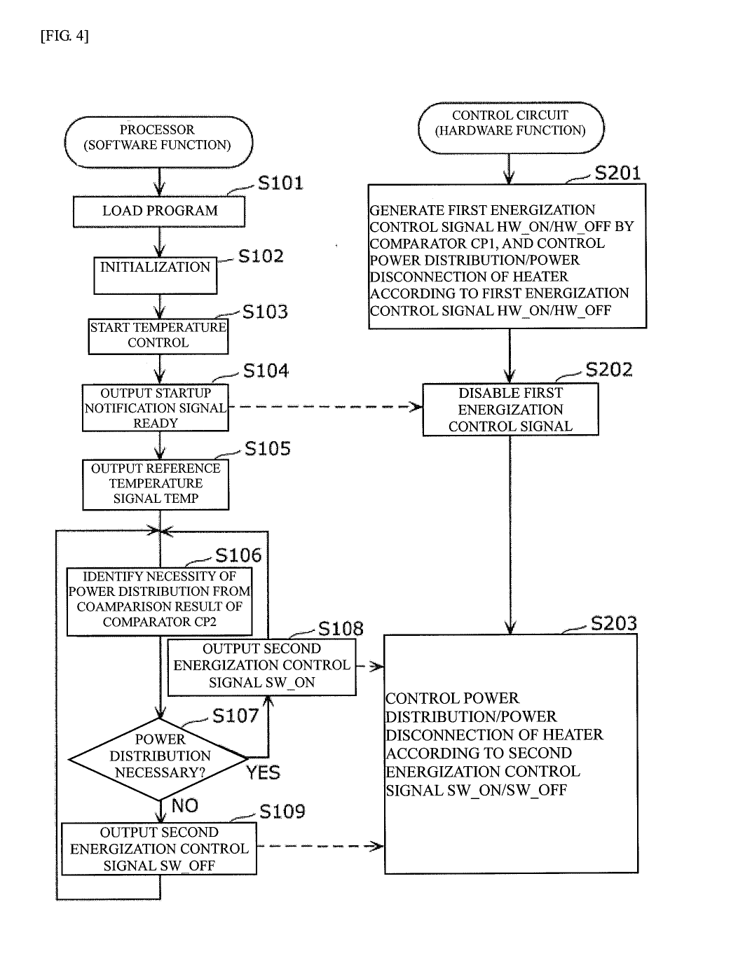

FIG. 4 is a flow chart as one example of the operation of the printing device 1, illustrating the operation carried out in the controller 60 when the power supply is initiated at the time of startup. Such operation may be carried out, for example, when the power activation is operated by user while the power supply of the printing device 1 is turned off, or when a printing instruction is given from an information equipment while the printing device in a deep sleep mode state in which the supply of the main power is stopped.

The flowchart illustrated in FIG. 4 divides the operation of the controller 60: an operation where the processor carries out by software function and an operation carried out where the control circuit configured with hardware other than the processor is carried out by the hardware function.

The processor loads a program (S101). The program loading may include, for example, a program deployment process from ROM to RAM by the loader grogram. The processor may first carry out an initialization process (S102) when the operation is started according to the loaded program, and the temperature control may be started (S103) by the program thereafter.

In parallel with the operations in steps S101 to S103 that are carried out in the processor, the controller may carry out the temperature control (S201) by the hardware function. For example, the first energization control signal that instructs the power distribution (HW_ON) or the power disconnection (HW_OFF) may be generated according to whether the temperature of the fuser 50 reaches the target temperature by comparing the temperature signal SENSE and the threshold voltage VTH1 with the comparator CP1. The first energization control signal may be transferred to the relay RL via the OR gate G1, and the power distribution and the power disconnection to the heater 53 may be carried out according to the first energization control signal by the relay RL.

The processor may output the startup notification signal READY when the temperature control is started (S104). The transistor Q1 is turned on according to the startup notification signal READY to shift the threshold voltage VTH1. Accordingly, the first energization control signal may be fused in the L-level to instruct the power disconnection (HW_OFF) and be disabled (S202).

The processor may output a reference temperature signal TEMP (S105), acquire a comparison result signal from the comparison result signal from the comparator CP2, and identify the necessity of power distribution to the heater 53 from the acquired comparison result signal (S106). The details of the process for identifying the necessity of the power distribution are not limited; however, the necessity of the power distribution may be identified by, for example, a simple temperature control logic by comparing threshold values, or it may be identified based on a more advanced temperature control logic such as a hysteresis or predictive control.

The processor may output a second energization control signal (S107 to S109) that instructs one of the power distribution (SW_ON) or the power disconnection (SW_OFF) corresponding to the necessity of the identified power distribution.

The second energization signal may be transferred to the relay RL via the OR gate G1, and the power distribution or power disconnection is carried out (S203) to the heater 53 according to the second energization control signal by the relay RL.

According to the configuration and operation of one or more embodiments of the controller 60 as evident from the descriptions given above, the temperature control by the hardware function can be carried out in the control circuit in parallel with all the processing carried out until the temperature control is started by the software function.

For example, a situation is assumed where a printing device comprising just one processor and a process requires considerable time such as loading a program must be carried out by the processor when the power supply is initiated. Even in such situation, the controller 60 may start heating in the fuser at the same time when the power supply is initiated by carrying out the temperature control by the hardware function in the control circuit in parallel with the processing so that the time required for the first print can be reduced.

Further, the configuration of the controller 60 may be applied to, for example, the processor for carrying out the temperature control in the fuser with a printing device comprising two or more processors. Accordingly, at the same time the power supply is initiated, heating in the fuser may be started by carrying out the temperature control by the hardware function in the control circuit and at the same time, the processing that require a considerable time such as loading a program is carried out in parallel and distributed to two or more processors so that the time required for the first print can be reduced.

Descriptions of the printing device according to one or a plurality of modes of the present invention were given above based on the embodiments; however, the present invention is not limited to the embodiments. Without departing from the spirit of the present invention, various modifications that can be conceived by one skilled in the art, or a mode that is built by combining compositional elements in a different embodiment may be included within the scope of one or more aspects of the present invention.

One or more embodiments of the present invention can be widely used in printing devices having a fuser that requires temperature control, for example, laser printers, LED printers, or the like.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF THE NUMERICAL REFERENCES

1 printing device
10 paper feeding section
20 printing unit
30 paper discharging section
40 image forming unit
41 photosensitive drum
42 transfer roller
50 fuser
51 heating roller
52 pressure roller
53 heater
54 temperature sensor
60 controller
70 power supply
91 printing medium
92 toner
CP1, CP2 comparator
CPU processor
DAC DA convertor
G1 OR gate
Q1 transistor
R1, R2, R3 resistor
RL relay

What is claimed is:

1. A printing device, comprising:
a heater that heats a fuser to fuse toner on a printing medium;
a sense circuit that generates a temperature signal indicating a voltage value corresponding to a temperature of the fuser;
a comparator that compares the voltage value indicated by the temperature signal with a threshold voltage value corresponding to a target temperature for the fuser and outputs a first energization control signal that maintains the temperature of the fuser at the target temperature;
a processor that executes a program after a power supply for the printing device is initiated and outputs a second energization control signal that controls the temperature of the fuser; and
an energization control circuit that, before the processor starts execution of the program, controls power distribution to the heater according to the first energization control signal, and, after the processor has started execution of the program, controls the power distribution to the heater according to the second energization control signal.

2. The printing device according to claim 1, wherein
the processor, by executing the program, further outputs a startup notification signal, and
the energization control circuit comprises a disabling circuit that disables the first energization control signal according to the startup notification signal.

3. The printing device according to claim 2, further comprising:
a threshold voltage generating circuit that comprises a plurality of resistors connected in series and that outputs the threshold voltage value from a connection point of the resistors by applying a predetermined voltage to both ends of the resistors, and
the disabling circuit comprises a transistor that connects the connection point and one of the end points of the threshold voltage generating circuit according to the startup notification signal.

4. A method for a printing device, comprising:
generating a temperature signal indicating a voltage value corresponding to a temperature of a fuser of toner;
comparing the voltage value indicated by the temperature signal with a threshold voltage value corresponding to a target temperature for the fuser;
outputting a first energization control signal that maintains the temperature of the fuser at the target temperature;
controlling power distribution to a heater according to the first energization control signal;
executing a program after a power supply for the printing device is initiated and outputting a second energization control signal that controls the temperature of the fuser; and
controlling, before the processor starts execution of the program, power distribution to the heater according to the first energization control signal, and controlling, after the processor has started execution of the program, the power distribution to the heater according to the second energization control signal.

5. The method according to claim 4, further comprising:
outputting a startup notification signal; and
disabling the first energization control signal according to the startup notification signal.

6. The method according to claim 5, wherein the printing device comprises a threshold voltage generating circuit that comprises a plurality of resistors connected in series, the method further comprising:
outputting the threshold voltage value from a connection point of the resistors of the threshold voltage generating circuit by applying a predetermined voltage to both ends of the resistors; and
the energization control circuit connecting the connection point and one of the end points of the threshold voltage generating circuit according to the startup notification signal.
